(19) United States
(12) Patent Application Publication
(10) Pub. No.: US 2003/0170143 A1
(43) Pub. Date: Sep. 11, 2003

(54) TEST DEVICE FOR MASS SCREENING

(76) Inventor: ROBERT WILLIAM CUNNINGHAM, TYNE ?amp; WEAR (GB)

Correspondence Address: DAVID A JACKSON, KLAUBER & JACKSON, 411 HACKENSACK AVENUE, HACKENSACK, NJ, 07601

(21) Appl. No.: 09/230,137

(22) PCT Filed: Jul. 16, 1997
(86) PCT No.: PCT/GB97/01939

(30) Foreign Application Priority Data
Jul. 17, 1996 (GB) 9614851.5

(51) Int. Cl. G01N 31/22

(52) U.S. Cl. 422/57; 422/55; 422/59; 422/65; 435/7.21; 435/7.25

(57) ABSTRACT

The invention discloses a test device comprising a substrate suitably adapted so as to provide aperture(s) wherein said aperture(s) are suitably adapted so as to support selected supportive material (3) so that fluid samples can be efficiently dispensed onto said supportive material (3) located within said apertures. Furthermore, said supportive material is further adapted so as to provide suitable guide means for checking the adequacy of the sample collected. Subsequently said test device can be placed in a suitable pouch (12) or the like, wherein said pouch (12) is adapted so as to provide desiccant properties (13) and thus to dry a fluid sample more efficiently. Eventually said test device is presented to an automated analyser for processing or the like, alternatively, said test device may be adapted so as to provide on the spot results. The device can said test device may be adapted so as to provide on the spot results. The device can be used for a variety of genetic, infectious or metabolic diseases and/or conditions and provides a user-friendly, cost effective, efficient means of mass screening.

The invention relates to a test device for use particularly but not exclusively, in automated testing apparatus and is particularly advantageous for the handling, drying, storage, transport or the like and subsequent analysis of fluid samples or the like.

Mass screening of specific subsections of the population for a range of diseases and conditions to which members of that subsection are susceptible is a well known early warning health care measure. The aim of such screening is, principally, not to diagnose those people with the disease or condition but, rather, to reject the vast majority of the people who are clearly normal. Those who show abnormal results can then be further examined to provide a diagnosis.

A typical procedure for testing a particular cross section of the population would involve the taking of a sample of bloods urine or saliva, for example. This is usually done in a clinic, surgery or hospital where there are specialised staff ready to process, package and label such samples for transportation to a specialised laboratory for further analysis.

There are many diseases and conditions which cart be screened in this way. For example; osteoporosis in post-menopausal women; inborn errors of metabolism such as phenylketonuria; metabolic disorders such as thyroid disease; clinical conditions such as neuroblastoma in children; drug and/or alcohol abuse; chromosomal abnormalities; infectious diseases; DNA profiling and the like. However, current methods and procedures for mass screening and subsequent analysis are particularly time consuming for the specialised laboratory and are, as a result, expensive.

The time consuming nature of such methods, is apparent from conventional neo-natal screening of babies. Usually, a nurse will prick the heel of, typically, a five day old infant with a needle in order to obtain a blood sample. The blood is deposited in several, usually four, predetermined locations on an absorbent test card. Each location is usually defined by a printed circle on the test card. The card also contains space for identifying details of the child under examination etc.

In order that later testing in the laboratory is carried out on approximately the same quantity of blood from each child the nurse will normally try and ensure that within each printed circle of the card there is evenly and completely impregnated a sample of blood. This is not always possible to achieve as the child may, for example, wriggle against the paper thereby smearing blood over a greater area so that a second application is required.

Once the blood has been collected on to the absorbent test card, it must be dried prior to insertion in an envelope, or other suitable caring means, for subsequent postage or transportation to an analysis laboratory. Air drying of samples is the method usually adopted. Typically, the nurse will move the card backwards and forwards through the air for a few minutes to facilitate drying. It is not uncommon, however, for incompletely dried samples to be placed within an envelope for transportation to the laboratory. This is to be expected given that complete drying in static air of blood samples absorbed on material, such as filter paper, can take up to four hours.

The next stage of the procedure takes place in the analysis laboratory. The technician manually punches a hole in the blood impregnated portion of the test card, judging by eye the optimum position from which to take a sample Typically a 3 mm circle of card will be removed. This is then placed in a test tube containing a reagent into which the blood passes. The sample of card is removed from the test tube leaving the blood sample ready to be fisher

Alternatively, instead of absorbent material such as filter paper, a hydrophobic membrane is used as a supportive material on which blood samples are collected. Such a sample is dried as before and sent to a laboratory for analysis. Once in the laboratory, the sample may be removed by the passing of water, or other suitable solvent, over the hydrophobic membrane so that the sample is simply washed into, for example, a test tube.

Ideally, the quantity of blood obtained for each test from each child is approximately constant Hence the use of a standard 3 mm card sample. Typically, two tests are carried out on samples from each child, one for phenylketonuria and the second for thyroid disease. The absorbent test card, containing any remaining samples, is stored in case the need for repeat or further tests should arise.

Mass screening for osteoporosis in post-menopausal women is similarly time consuming in that, a mid stream urine sample obtained from the patient in, for example, a bottle must be labelled and stored and later transported to a laboratory for subsequent analysis. Samples contained in bottles require specialised packing arrangements in order that these can be transported safely and securely. This sample management is an essential though repetitive and menial task that is usually carried out by professional staff. At present, such samples can be obtained by patients in the privacy of their own homes, but these are then later taken, usually by hand, to a clinic for further processing.

A system for the collection of a saliva sample by a patient at home has already been developed. This system incorporates a piece of absorbent paper fixed on the end of a holding stick. The paper is placed in the mouth using the holding stick. Following absorbtion of saliva, the paper is placed in a buffer solution contained in a small sealable bottle. The entire arrangement of paper, stick, buffer solution and bottle are then taken to a laboratory. In this way, the integrity of a fluid sample obtained by a patient at home is preserved during storage and transport of the sample.

There are several problems to the use of such procedures for the mass screening of the population.

Firstly, if a test card is used, there is a risk of contamination of the samples by contact with eternal objects, in particular, surfaces. This can occur when the test card is completely dry, but it is especially a problem when a damp card is placed in, for example, an envelope. It is impractical for a nurse in the field to wait up to four hours for the test card to be completely dry before handling it further.

The transportation of bottled samples poses particular problems in that bottles have a 3-D shape and are less easy to label and send by post. In addition, there is always an inherent risk of leakage and/or breakage which not only results in the loss of the sample but can prove hazardous. Furthermore, samples stored in liquid form are inherently susceptible to deterioration and contamination, particularly if storage conditions, such as temperature etc., are not adequately controlled. Storage of dry samples, however, effectively freezes said samples at a point in time such that little or no deterioration occurs.

Secondly, the manipulations to be carried out by professional staff such as a nurse or doctor in the clinic in labelling and packaging such samples, and a technician in the laboratory in pressing such samples, are of a highly repetitive and time consuming nature.

Thirdly, the value judgement of the laboratory technician in determining the optimum place on a test card to punch and so obtain samples, is open to error, particularly because of the repetitive nature of the work

Fourthly, the cost of mass screening lies predominantly in the time taken to obtain, process, transport and analyse each sample from each patient. Currently, professional staff are involved in each of these stages.

The cost of mass screening could be significantly reduced, if people could, in the privacy of their homes, provide samples of, for example, blood, urine or saliva or any other body fluid which can be safely stored and/or sent to a central analysis centre without the risk of contamination and without the need for the involvement of professional staff.

Indeed, tile cost of mass screening of fluid samples from a variety of sources could be reduced if such samples could be transported and analysed in the above manner. Examples of sources from which fluid samples could be taken include natural water courses, household or industrial water tanks and pipes, household pets and farm animals.

The invention of the device has elegantly and inventively overcome many of the problems associated with the prior art by providing a U.S.S.R. friendly, effective test device comprising a substrate suitably adapted so as to provide aperture(s) wherein said apertures are suitably adapted so as to support selected supportive material so that fluid sample(s) can be efficiently dispensed onto said supportive material located within said aperture(s). Furthermore, said supportive material is further adapted so as to provide suitable guide means for checking the adequacy of the sample collected. subsequently said test device can be placed in a suitable pouch or the like, wherein said pouch is adapted so as to provide dessicance properties and thus to dry a fluid sample more efficiently. Eventually said test device is presented to an automated analyzer for processing or the lie.

In its broadest aspect the invention provides a mass screening test device capable of collecting multiple body fluid samples for subsequent or in situ analysis.

It is therefore an object of the invention to provide a test device and carrying means or envelope to facilitate the taking of samples and the subsequent postage or transportation to a laboratory, which test device, in addition, is further adapted to be used in conjunction with automated testing apparatus.

It is a yet further object of the invention to provide a means for confirming the adequacy of the sample collected.

It is yet a further object of the invention to provide a reliable test device for

It is a yet further object of the invention to provide a test device for use with any body fluid and/or matter such as blood, urine, saliva, faeces or the like.

In a first aspect of the invention there is provided a test device for use in automated testing apparatus comprising supportive material mounted on at size and shape and comprising at least one indentation or aperture of predetermined location, size and shape over which said supportive material is at least partially positioned, whereby the positioning of a sample to be tested on said supportive material can be recognized by automated testing apparatus and said sample to be tested can be optionally removed therefrom.

In a preferred embodiment of the invention, the supportive material is spaced from an outermost surface of said substrate. Ideally, the supportive material is sandwiched between two substrates whereby, the supportive material is spaced from said outermost surface by the thickness of one substrate. plurality of evenly spaced first indentations or apertures.

Ideally, the substrate or substrates of said test device is or are adapted to be easily manipulated by automated testing apparatus, Preferably, the test device comprises a holding means, such as ridges or holes, whereby the handling of the test device by automated apparatus is facilitated. Preferably, said first aperture is a throughbore.

In a yet further preferred embodiment of the invention at least a part of at least one surface of said support material is provided with a suitable hydrophobic material ideally said hydrophobic material is latex or wax or the

In a yet further preferred embodiment of the invention said hydrophobic material is suitably configured so as to provide a guide means comprising typically a line of said hydrophobic material wherein said configuration is such that ideally a circular portion and a channel portion is defined, wherein following application of a fluid sample, fluid is allowed to permeate to an edge of said circular portion and excess fluid is directed along said channel portion.

In a yet further preferred embodiment of the invention said substrate is provided with at least one second aperture or indentation suitably sized and shaped and positioned, with respect to said first aperture, so as to be aligned with said channel portion of said guide means. in a yet further preferred embodiment of the invention there is provided an indicator means suitably positioned with respect to said second aperture indentation, ideally said indicator means is associated with or impregnated with or cross-linked to or coated onto at least a part of a least one surface said supportive material.

In a yet further preferred embodiment of the invention the diameter of said guide means circular portion is greater than the diameter of the first aperture or indentation diameter and ideally is greater in diameter in the region of 1-5 mm and most ideally 2-3 mm.

In a yet further preferred embodiment of the invention, the supportive material or a least a part of the surface of the supportive material is adapted to efficiently and, ideally, quickly distribute a fluid sample into at least a part of the supportive material or across at least a part of the surface of the supportive material. This can be achieved by modifying physically or chemically the nature of the surface. Preferably, the supportive material is absorbent in nature, such as, filter paper. Alternatively, the supportive material may be a hydrophobic membrane.

In a yet further preferred embodiment of the invention said supportive material or at least part of the surface of said supportive material is associated or impregnated with or cross-linked to or comprises or is coated with a suitable selected material whereby a fluid sample can react directly with said material in a colourmetric and/or fluorometric and/or luminometric and/or radiometric manner whereby fluid samples may be analysed at the point in time of collection.

In a yet further preferred embodiment of the invention said test device is provided with an identification means.

In a yet further aspect of the invention, there is provided a pouch for receiving a test device, according to the invention.

Ideally, the pouch comprises a desiccant layer. Preferably, the desiccant layer comprises at least a part of at least one surface, ideally the inner surface, of the pouch.

In a further preferred embodiment of the invention, the pouch comprising a desiccant layer, is so sized and shaped so that when a test device is inserted into the pouch, the supportive material contained in the test device is opposite or adjacent the desiccant layer. Preferably, the desiccant layer comprises silica gel. Furthermore, the pouch, at least a part of its outer surface, may comprise impervious material.

In a yet further aspect of the invention, there is provided a test kit comprising at least one test device according to the invention and at least one pouch according to the invention

In a yet further aspect of the invention, there is provided a test kit comprising a test device, and a pouch according to the invention and a means for obtaining a sample. Ideally, the means for obtaining a sample comprises a lance or blade, preferably automatic, if a blood sample is required, a pipette if a saliva sample is required, and/or, possibly, a container if a urine and/or stool sample is required. In addition, the test kit may comprise instructions and/or a bar code for identifying purposes.

Ideally, the bar code is used to indicate the identity and origin of each individual test device, the type of test to be carried out and/or the particular shape of the test device whereby automated testing apparatus can be automatically reconfigured following reading of the bar code to accommodate test devices of a variety of shapes and for a variety of tests.

In a yet further aspect of the invention there is provided a method for confirming the adequacy of a collected fluid sample comprising;

i) providing a supportive material on which there is imprinted a suitable hydrophobic material which defines a guide means comprising a deposition portion and a channel portion;

ii) placing said fluid sample on said deposition portion and allowing said fluid sample to fill and/or permeate into said channel portion;

iii) collecting sufficient fluid of said sample so that said sample passes over an indicator means in or associated with said channel portion;

iv) assessing said collected fluid sample by visualisation of said indicator means and/or by automated machine analysis of said indicator means.

Particular embodiments of the invention will now be described with reference to the accompanying drawings and by way of example only.

### IN THE ACCOMPANYING DRAWINGS:

FIG. 1a shows a plan view of a test device in accordance with the invention.

FIG. 1b shows a side sectional view of a device in accordance with the invention.

FIG. 1c shows a plan view of a section of supportive material.

FIG. 1d shows a plan view of an alterative test device in accordance with the invention.

FIG. 2a shows a plan view of an alternative test device in accordance with the invention.

FIG. 2b shows a side view of an alternative test device in accordance with the invention.

FIG. 3 shows a plan view of an alternative test device in accordance with the invention.

FIG. 4a shows a plan view of an alternative test device in accordance with the invention.

FIG. 4b shows a side view of an alternative test device in accordance with the invention.

FIG. 5a shows a plan view of an alternative test device in accordance with the invention.

FIG. 5b shows a side view of an alternative test device in accordance with the invention.

FIG. 6 shows a perspective view of a pouch and a test device in accordance with the invention.

FIG. 7 shows a sectional view of a pouch in accordance with the invention.

FIG. 8 shows a sectional view of an alternative pouch in accordance with the invention.

Particular embodiments of the invention will now be described.

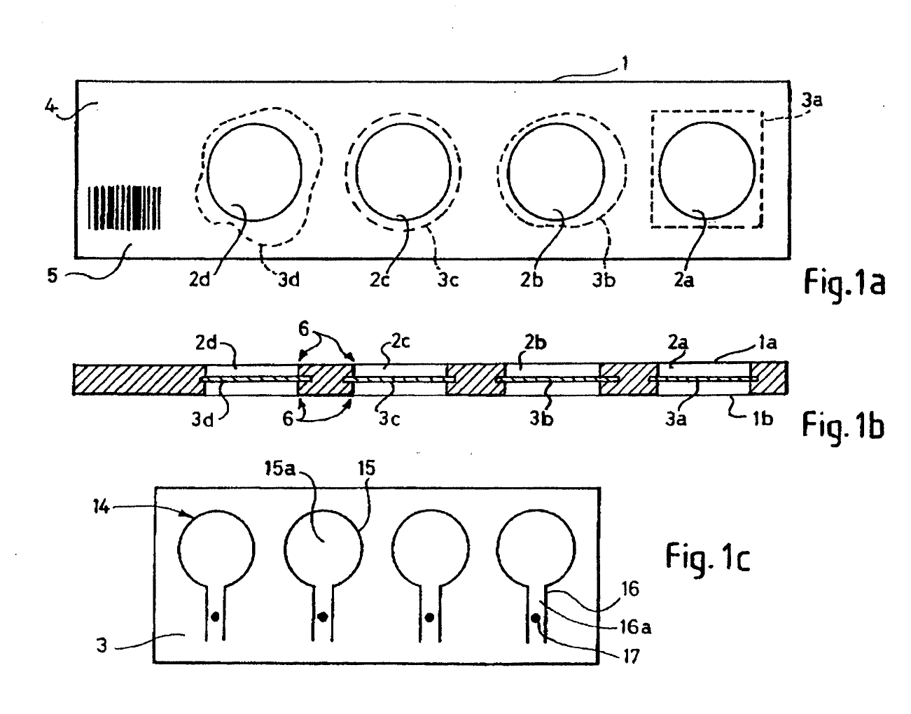

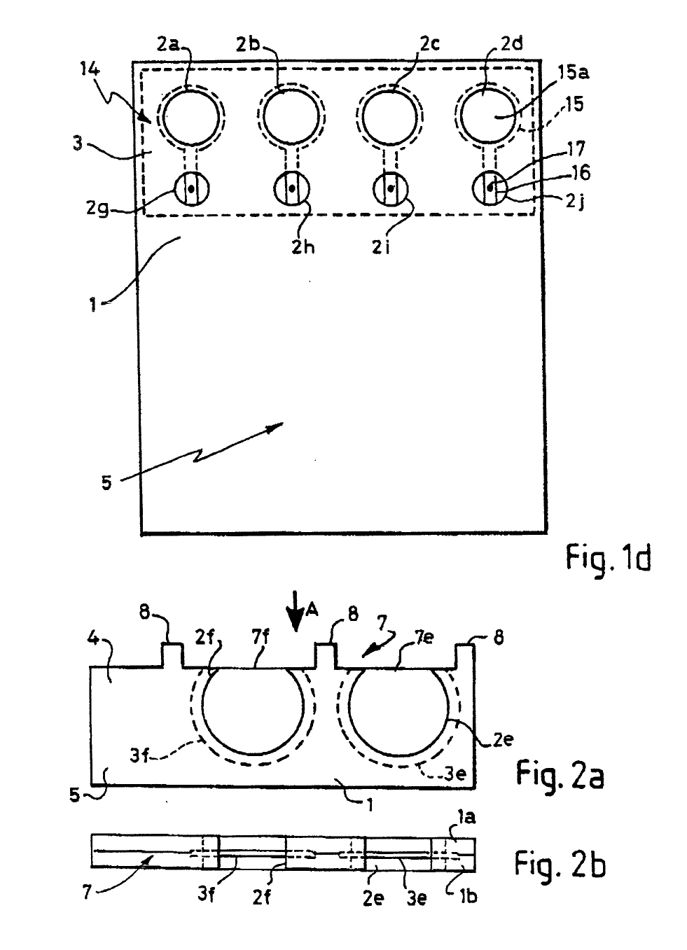

Referring firstly to FIG. 1a, rectangular substrate 1 is clearly shown. Substrate 1 comprises four first apertures 2a, 2b, 2c and 2d of a particular size, shape and location. Substrate 1 may be made of any suitable non-absorbent material such as plastic. In this particular embodiment, the first apertures, generally labelled 2, are circular. Towards one end of the substrate 1 is provided a region for noting the identifying particulars of a patient by means of a label or otherwise. There is also provided a region 5 comprising a bar code. The bar code can be used to include several pieces of information for later use by automated testing apparatus. This information may comprise, for example, the batch number or identifying number of each individual test device, the type of test device used ie its particular shape or geometric orientation and/or a specific test or tests that are to be undertaken on the samples located within the test device. The use of a bar code containing such information facilitates the use of such test devices in automated analytical apparatus.

Spanning first apertures 2 are correspondingly numbered sections of supportive material labelled 3a, 3b, 3c, and 3d, which supportive material sections may be a variety of shapes as shown clearly in FIG.1a. For example, supportive material section 3a is generally square whereas supportive material section 3c is generally circular.

The supportive material located within each aperture may be absorbent or adapted to facilitate wetting of a fluid sample to the surface of the material. This can be achieved in a number of ways, for example, the use of absorbent materials, such as filter paper. Alternatively, a surface wetting agent may be applied to a part of the exposed surface of each supportive material section.

Turning now to FIG. 1b, first apertures 2 are clearly shown to be throughbores. Furthermore, substrate 1 is clearly shown to comprise an upper portion 1a and a lower portion 1b which are aligned and sandwiched together so as to provide apertures 2. Furthermore, portions 1a and 1b enclose and support the supportive material sections 3a, 3b, 3c and 3d, so that supportive materials span each of the first apertures 2.

Alternatively, this may be achieved by a piece of supportive material 3 (not shown) spanning all the first apertures in substrate 1.

As can be seen clearly from FIG. 1b, supportive materials sections 3a, 3b, 3c and 3d art suspended tightly across first aperture 2 (similarly a single piece of supportive material 3 may be so arranged), so as to safeguard against sections 3a, 3b, 3c and 3d (or material 3) making contact with adjacent objects. In this way, contamination of samples carried on sections 3a, 3b, 3c and 3d or (supportive material 3) is avoided. Upper or lower outermost edges 6 of first aperture 2 may be adapted to allow easy access of a finger, or other sample supporting means, to the supportive materials sections 3a, 3b, 3c and 3d (or material 3).

Referring now to FIG. 1c there is shown a section of support material (3) and provided on at least one surface of said support material there is provided at least one guide means (14) wherein said guide means is configured so as to provide a circular portion (15) and a channel portion (16). The delineation of said guide means (14) is provided by a hydrophobic material such as latex or wax or the like and the configuration provides for a fluid sample to permeate across the region (15a) and upon reaching an edge of circular portion (15) fluid is directed along region (16a) of channel portion (16) so as to pass over indicator means (17). Indicator means (17) comprises an indicator printed onto the surface of said supportive material so that fluid samples passing thereover can react with said indicator means so as to illicit a change of colour, in the instance of said indicator means comprising an anhydrous copper sort or the like. Activation of said indicator means thereby assures the adequacy of the fluid sample collected. The size and shape of the guide means may be varied according to a user's requirement.

Referring now to FIG. 1d, there is shown supportive material (3) as depicted in FIG. 1c placed rearward of substrate (1). Additionally provided on substrate (1) is region (5) comprising a bar code. First apertures 2a, 2b,2c,2d of substrate (1) are suitably positioned over guide means (14) so as to be aligned with the circular portion (15) of said guide means (14) so as to accommodate fluid sample collection. Channel portion (16) of guide means (14) is aligned with second apertures 2g, 2h, 2j, 2i of substrate (1) so that indicator means (17) are suitably positioned so as to be observed or analysed in either a manual or an automatic manner thereby ensuring adequacy of sample collection to be directly and/or indirectly observed. In operation, fluid samples are collected on area (15a) and permeate outwards to the edge of circular portion (15a) and excess fluid is directed along channel (16) so as to pass over indicator means (17) whereby fluid sample collection maybe ensured and/or checked by appropriate activation of said indicator means

FIGS. 2a and 2b show an alternative embodiment of a test device. Corresponding labels refer to corresponding portions of the test device as previously described. In this embodiment, indentations 2e and 2f are located in substrate 1 such that side 7 of substrate 1 is apertured or cut away at the location of indentations 2e and 2f. Corresponding supportive material 3e and 3f respectively is sandwiched between portions 1a and 1b such that the sides of indentations 2e and 2f substantially surround supportive material sections 3e and 3f. Adjacent to side 7 of substrate 1 are exposed edges 7e and 7f of supportive material sections 3e and 3f respectively.

Exposure of edges 7e and 7f aid the application of, for example, a finger on which there is a rood spot, to supportive material 3e and 3f in general direction A. Furthermore, the addition of stops 8 reduce the risk of contacting edges 7e and 7f to external surfaces and, therefore, reduce the risk of contamination of samples contained on 3e and 3f.

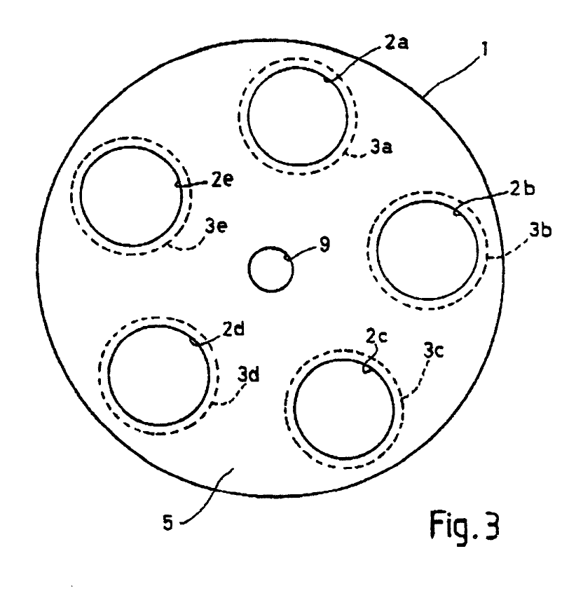

Referring now to FIG. 3, an alternative embodiment of a test device is shown in which a plurality of fist apertures 2 are disposed about a generally circular substrate 1. Means may be provided on substrate 1 for the handling of the test devise in automated test apparatus. In this embodiment, a hole 9 is provided for this purpose.

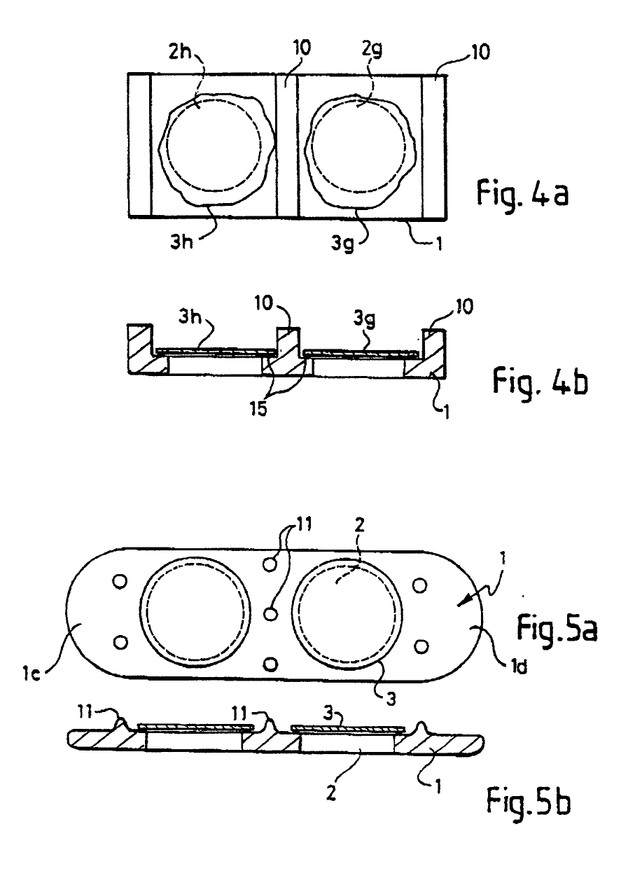

Turning now to FIG. 4, an alternative embodiment of the test device according to the invention is shown. Features described previously have been accorded corresponding labels.

In this embodiment, supportive material 3 is attached to one side of substrate 1 by fixing means 15. Ridges 10 serve to space sections 3 from contact with external objects so reducing the risk of contamination of the samples carried on sections 3. Ridges 10 may also serve as handling means for the test device for both manual and machine handling.

In FIG. 5 a test device is shown. Projections 11 are used to provide spacing between material 3 and any external surfaces. The distribution of projection 11 may be optimised so that access to material 3 during sample deposition is made easier. Furthermore. in this embodiment, substrate 1 is shown to have an ergonomic shape in that sides 1c and 1d are smoothed and rounded. This adaptation is particularly useful for test devices that are to be used for the collection of, for example, a mid-stream urine sample.

It will be understood from the above that substrate 1 may be of a variety of shapes and forms and the number, size and shape of first and second apertures 2 may vary according to the requirements of a particular test or tests to be carried out. The above embodiments are merely examples of possible arrangements for a test device. It is envisaged that the number and size of apertures will vary according to the number of tests to be carried out, the number of samples to be stored for future use and the quantity of sample required for any one test.

It will also be understood that different sized and shaped apertures may be provided on a single test device and further said test device may be subject to analysis using more than one type of test.

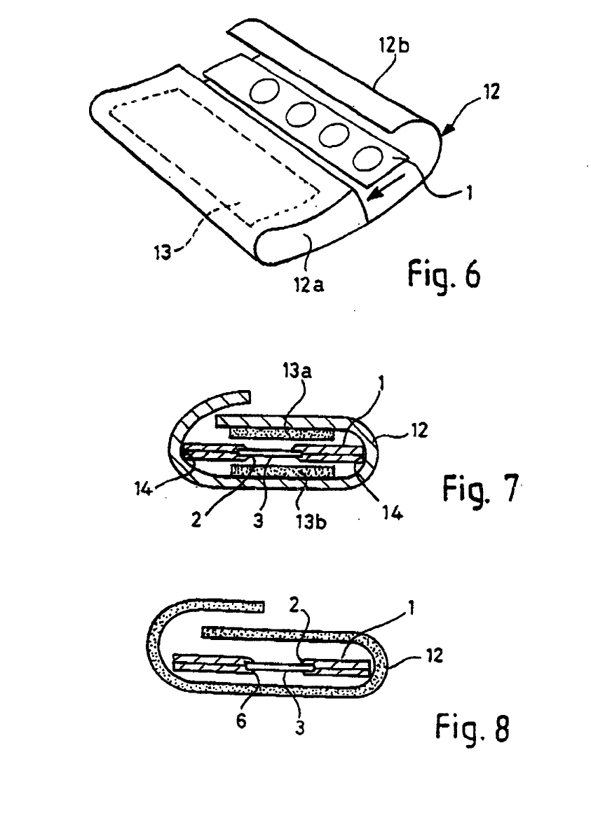

In a further aspect of the invention, shown in FIG. 6, a carrying pouch 12 is provided. Pouch 12 comprises a receiving portion 12a and a sealing portion 12b. Pouch 12 may be made of, for example, any suitable impervious material.

Test device 1 is inserted into receiving portion 12a, and pouch 12 is subsequently sealed using portion 12b.

Ideally, as shown in FIG. 7, pouch 12 is so sized and shaped such that test device 1 is securely located inside the pouch by means of edges 14 of test device 1 abutting against the inner sides of pouch 12. In the particular embodiment shown in FIGS. 6 and 7, desiccant layers 13a and 13b are provided on the inner surfaces of pouch 12. The location of layers 13a and 13b is such that following insertion of test device 1, the layers are substantially adjacent first apertures 2 and supportive material sections 3.

Alternatively, layers 13a and 13b may be arranged as afore and embedded in pouch 12.

Alternatively, the sides of pouch 12 may be made almost entirely from a desiccant material such that the entire test device 1 is surrounded by a desiccant layer, see FIG. 8. In this case, the precise relative geometry of pouch 12 and test device 1 is not so critical since all of device 1 is encompassed within a desiccant atmosphere. However, whatever the preferred arrangement, test device 1 and pouch 12 will normally be designed so that there is little relative movement between them when test device 1 is located within pouch 12.

Silica gel may be used inside layer 13 or the sides of pouch 12 in order to provide a desiccant atmosphere.

In use a patient will be provided with a kit comprising a test device, a pouch, sample obtaining means and instructions.

In order to obtain, for example, a blood sample, a lance or blade, preferably automatic, will be provided. The usual place from which a patient obtains a sample of his or her own blood is in the fleshy part of the fingers. if this is the chosen site, the hands must be washed and then the lance or blade used to pierce the finger. Once a spot of blood has accumulated, this can be lightly touched to the supportive material, within an aperture. of a test device. This is repeated at further locations on the test device until the required number of samples have been obtained.

The test device may then be inserted directly into a pouch 12 as shown in FIGS. 6-8 following minimal drying time. The entire arrangement can then be sent, preferably, be post, to an analysis laboratory. The presence of the desiccant within the pouch will ensure that samples are continually exposed to a dry atmosphere during transport to the laboratory so, that further evaporation of moisture from the samples is encouraged. Furthermore the test device ensures that contact between the supportive material impregnated with samples and the inner surfaces of the pouch is not possible.

Alternatively, samples of saliva may be required. In this ease, a pipette may be used to obtain a quantity of saliva from the mouth. This is then applied to the supportive material at the required number of locations. The test device may then be sent to an analysis centre.

If a sample of urine is required, the patient has two options. Firstly, he may collect urine in a bottle provided with the test kit and then apply a sample of the urine to the supportive material within a number of apertures. Secondly, and alternatively, or in addition, the test device may be so adapted as to be held adjacent to the urine stream during excretion of urine. In this latter case, it may be advantageous to wait a few moments for excess droplets to fall from the test device before insertion into the pouch and subsequent postage.

Once a test device is received at an analysis laboratory, it is loaded into automatic testing apparatus by a technician. Subsequently, the apparatus, typically, reads the bar code, identifies the type and number of tests to be carried out and the geometry of the test device. In addition, the apparatus locates and punches out, or otherwise removes, the required number of samples from within the corresponding number of apertures.

Fluid samples may be obtained from a variety of different sources, for example, farm animals, household pets, waterways such as rivers, streams and sewage pipes and household pipes and tanks. Subsequent testing, particularly for pipes, tanks and water courses may be directed towards the detection of, for example, particular strains of bacteria as well as evidence of diseases.

It can be seen that use of a test device and carrying pouch according to the invention greatly facilitates the drying, storage, transport and subsequent analysis of fluid samples.

It will be understood from the above that, the use of such test kits comprising a test device and carrying pouch, by, for example, patients in the privacy of their own home and subsequent postage to an analysis laboratory will greatly reduce the demands on the time of professionals in, for example, clinics, surgeries and hospitals. In this way, the cost of mass screening and in particular mass screening of specific subsections of the population is significantly decreased. Indeed, the use of mass screening for a far greater number of diseases and conditions will now be commercially viable. As a result, it can be seen that the current invention provides a significant advance over the prior art.

1. A test device for use in automated testing apparatus comprising:a substrate of predetermined size and shape, so as to facilitate handling by said automated testing apparatus, and including at least one indentation or aperture wherein said indentation or aperture is of a predetermined location, size and shape with respect to said automatic testing apparatus; and further comprising supportative material mounted on at least a part of said substrate so as to be at least partially positioned over said indentation or aperture; and wherein said supportative material comprises a guide means characterised by a sample deposition portion and attached thereto a channel portion including an indicator means; whereby the positioning of a sample to be tested on said sample deposition portion of said supportive material results in said sample travelling along said channel portion and interacting with said indicator means so as to provide a measure of the adequacy of the fluid sample collected.

2. A test device according to claim 1 wherein said supportive material is spaced from an outer most surface of said substrate.

3. A test device according to claims 1 or 2 wherein said supportive material is sandwiched between two substrates.

4. A test device according to any preceding claim wherein said substrate is provided with a plurality of spaced first indentations or apertures.

5. A test device according to claim 4 wherein said first indentations or apertures are evenly spaced there apart.

6. A test device according to any preceding claim comprising a holding means, whereby the handling of said test device by automated apparatus is

7. A test device according to any preceding claim wherein at least a part of at least one surface of said supportive material is provided with a suitable hydrophobic material.

8. A test device according to claim 7 wherein said hydrophobic material is latex or wax or the like.

9. A test device according to any preceding claim wherein said substrate is provided with at least one second indentation or aperture suitably sized and shaped and positioned, with respect to said first aperture, so as to be aligned with said channel portion of said guide means.

10. A test device according to claim 9 wherein said indentation or aperture is positioned so as to be aligned with said indicator means.

11. A test device according to any preceding claim wherein said indicator means is associated with, or impregnated with, or cross-linked to, or coated onto, at least a part of at least one surface of said supportative material.

12. A test device according to any preceding Claim wherein said sample deposition portion is circular and the diameter of same is greater than the diameter of the first indentation or aperture.

13. A test device according to claim 12 wherein said sample deposition diameter is greater or in the region of 1 to 5 mm.

14. A test device according to any preceding claim wherein said supportive material, or at least a part of said supportive material, is adapted to efficiently and quickly distribute a fluid sample into at least a part of the supportive material or across at least part of said supportive material.

15. A test device according to any preceding claim wherein said supportive material is absorbent in nature.

16. A test device according to any preceding claim wherein said supportive material comprises a hydrophobic membrane.

17. A test device according to any preceding claim wherein said supportive material is provided with colourmetric and/or fluorometric and/or luminometric and/or radiometric indicator means whereby fluid samples may be analysed.

18. A test device according to any preceding claim wherein said device is provided with identification means.

19. A pouch that is of a size and shape that corresponds to the size and shape of the test device according to any preceding claim.

20. A pouch according to claim 19 wherein said pouch comprises a

21. A pouch according to claim 20 wherein said desiccant comprises at least a part of at least one surface of said pouch.

22. A pouch according to claims 20 or 21 wherein said desiccant is provided on an inner surface of said pouch.

23. A pouch according to claims 20 to 22 wherein said pouch comprises a desiccant surface which is so sized and shaped so that when the test device is inserted into the pouch the supportive material contained in the test device is opposite, or adjacent, the desiccant.

24. A pouch according to claims 20-23 wherein said desiccant comprises silica gel.

25. A pouch according to claims 19-24 wherein at least a part of its outer surface is made from impervious material.

26. A test kit comprising at least one test device according to claims 1 to 18 and at least one pouch according to claims 19-25.

27. A test kit according to claim 26 comprising a means for obtaining a sample.

28. A test kit according to claim 27 wherein said means for obtaining a sample comprises a lance or blade, if a blood sample is required; a pipette if a saliva sample is required; and/or a container if a urine and/or stool sample is required.

29. A test kit according to claims 26-28 comprising instructions and/or a bar code for identifying purposes.

30. A test kit according to claim 29 wherein an identification means is provided to indicate the identity and origin of each individual test device, the type of test to be carried out and/or the particular shape of the test device whereby automated testing apparatus can be automatically re-configured following reading of the identification means to accommodate test devices of a variety of shapes and for a variety of tests.

31. A method for confirming the adequacy of a collected fluid sample using the test device according to claims 1-18, comprising;
(i) providing a substrate of a predetermined size and shape, and including at least one indentation or aperture wherein said indentation or aperture is of a predetermined location, size and shape so as to facilitate handling by an automated testing apparatus; and farther comprising a supportative material mounted on at least a part of said substrate so as to be at least partially positioned over said indentation or aperture; wherein said supportative material comprises a guide means characterised by a sample deposition portion and attached thereto a channel portion including an indicator means;
(ii) placing a fluid sample on said sample deposition portion and allowing said fluid sample to fill and/or permeate into said channel portion;
(iii) collecting sufficient fluid of said sample so that said sample passes over said indicator means in or associated with said channel portion;
(iv) assessing said collected fluid sample by visualisation of said indictor means and/or by automated machine analysis of said indicator means.
